(19) United States
(12) Patent Application Publication
(10) Pub. No.: US 2003/0129446 A1
(43) Pub. Date: Jul. 10, 2003

(54) Multilayer structure used especially as a material of high relative permittivity

(75) Inventor: Lionel Girardie, Eybens (FR)

Correspondence Address: HESLIN ROTHENBERG FARLEY & MESITI PC, 5 COLUMBIA CIRCLE, ALBANY, NY, 12203, US

(73) Assignee: MEMSCAP Le Parc Technologique des Fontaines, Bernin (FR)

(21) Appl. No.: 10/328,880

(22) Filed: Dec. 24, 2002

(30) Foreign Application Priority Data
Dec. 31, 2001 (FR) 01.17069
Feb. 11, 2002 (FR) 02.01618
Feb. 27, 2002 (FR) 02.02461
Mar. 20, 2002 (FR) 02.03442
Mar. 20, 2002 (FR) 02.03445
Mar. 20, 2002 (FR) 02.03444
Apr. 17, 2002 (FR) 02.04782
Jul. 25, 2002 (FR) 02.09459

(51) Int. Cl. B32B 3/00

(52) U.S. Cl. 428/689

(57) ABSTRACT

Multilayer structure, used especially as a material of high relative permittivity, characterized in that it comprises a plurality of superposed elementary layers, each with a thickness of less than about 500 Å, among which there are two layers based on an alloy of titanium dioxide (TiO₂) and tantalum pentoxide (Ta₂O₅), these layers being separated by an interlayer of an alloy based on at least hafnium dioxide (HfO₂) an alumina (Al₂O₃).

### TECHNICAL FIELD

The invention relates to the field of microelectronics. It relates more specifically to a multilayer structure which can be used especially as a material of high relative permittivity. Such a material may be used to form the insulating layer of a capacitor. Such a capacitor may especially be used as a decoupling capacitor or as a filter capacitor integrated into radiofrequency circuits or the like.

This type of insulating material can also be used to be included in capacitive structures such as those forming the cells of embedded memories (embedded DRAMs). Such cells may be produced within an integrated circuit itself.

The invention also makes it possible to produce oxide gate multilayers (or gate stacks), also known as gate structure, that are found in transistors of a particular structure.

### PRIOR ART

In general, one of the generally desirable objectives for producing capacitive structures, whether they be capacitors or memory cells, is to increase the capacitance of the structure, that is to say the value of the capacitance per unit area, so as to minimize the size of the components.

This objective of seeking a higher capacitance is achieved especially by the use of dielectrics having as high a relative permittivity as possible.

The value of the capacitance also depends inversely on the distance separating the two electrodes of the structure. This is why it is generally sought to reduce the thickness of the layer of dielectric separating the two electrodes of a capacitive structure.

However, reducing this thickness poses certain physical problems that depend on the materials used. This is because when the dielectric layers are very thin, certain tunnel effect phenomena may arise that modify the behaviour of the capacitive structure, degrading the properties thereof.

Moreover, when a dielectric layer is subjected to too high a voltage, electrical breakdown phenomena may also arise. It is therefore possible to define, for each material, a maximum breakdown electric field above which it cannot be employed.

For example, certain materials are limited to voltages of the order of a few volts, whereas there is a need for capacitors, especially those used for decoupling operations, to be able to withstand voltages greater than 10 volts or so.

Furthermore, the level of leakage current is also a parameter that may be critical in some applications. Mention may especially be made of capacitors operating at high frequency, for which it is important for the behaviour of the capacitor to be maintained over the broadest possible frequency band. The level of leakage current is also critical for applications requiring a high degree of autonomy, when the capacitors are especially embedded in cordless appliances.

However, the level of leakage current depends especially on the crystalline structure of the dielectric.

Document FR 2 526 622 has proposed producing multilayer structures by combining titanium dioxide (TiO₂) and alumina (Al₂O₃) elementary layers so as to obtain materials having a relatively high permittivity.

This type of structure has the drawback that titanium dioxide (TiO₂) is a material having a low density and a permittivity that depends on the crystalline phase. It therefore means that it has to be coupled with a material having an amorphous phase, including up to a temperature of 800° C., and having a high breakdown field. This is why, to avoid increasing the leakage current, that document proposes the superposition of TiO₂ and Al₂O₃ layers. The electrical performance characteristics of the material are used for TFT (thin film transistor) applications but are insufficient for capacitor cell decoupling applications. This is because, for some applications, the leakage currents are the determining factors for radiofrequency (RF) operation and especially for the generations of devices based on HBT-CMOS and HBT-BICMOS technology that are used in cordless communications appliances, and especially the future generations of mobile telephones known as UMTS.

For the latter application, a standard on decoupling is such that it requires leakage currents of less than 10⁻⁹ A/cm² to be achieved at supply voltages of 5.5 V, by having a breakdown field of greater than 6 MV/cm. In order for such a dielectric to be able to be used in this application, it must possess a band gap energy of greater than 5.5 eV. However the TiO₂ and Al₂O₃ multilayer stack has only a band gap energy of 4 eV, a breakdown field of about 3.5 MV/cm and leakage currents close to 10⁻⁶ A/cm². It is very clearly apparent that the material described in that document, developed for TFT applications, cannot also be used for applications involving RF decoupling capacitors and capacitor cells incorporated into integrated circuits in HBT-CMOS and HBT-BICMOS technology.

It is one of the objectives of the invention to provide a material that can be used within various capacitive structures, which combines both a high relative permittivity value, with a high voltage withstand, and a low level of leakage current.

### SUMMARY OF THE INVENTION

The invention therefore relates to a multilayer structure that can be used especially as a material of high relative permittivity.

According to the invention, this structure is characterized in that it comprises a plurality of superposed elementary layers, each with a thickness of less than about 500 angströms (Å). Among these layers, there are at least two layers based on an alloy of titanium dioxide (TiO₂) and tantalum pentoxide (Ta₂O₅). These layers are separated by an interlayer of an alloy based on at least hafnium dioxide (HfO₂) and alumina (Al₂O₃).

In other words, the material obtained according to the invention is an alternation of films having differing compositions and possibly stoichiometries, for thicknesses of less than a few hundred angströms, thus forming a nanolaminated structure. In practice, the thickness of the layers may preferably be less than 200 Å, or even less than 100 Å, or indeed less than 50 Å.

Surprisingly, it has been found that titanium dioxide-tantalum pentoxide alloys have much more favourable properties in terms of breakdown field and leakage current than the two components of the alloy taken separately.

Thus, as explained above, titanium dioxide is known to have relatively high leakage currents, which result from the low stability of its crystalline structure. This is because above 300° C. the coexistence of two different phases is generally observed. This low stability is explained by a relatively low enthalpy of formation of the oxide.

In practice, it is found that the level of leakage current in TiO₂ layers alone is of the order of 100 microamps per square centimetre (100 μA/cm²). However, titanium dioxide is beneficial because its relatively permittivity is relatively high, typically around 50, for a deposition of 320° C.

The properties of tantalum pentoxide (Ta₂O₅) are relatively similar to those of titanium dioxide (TiO₂) so that it might be expected that an alloy produced from these two oxides would not be beneficial as regards the value of the leakage currents.

However, measurements carried out on these TiO₂-Ta₂O₅ alloy layers show, on the contrary, that the value of the leakage currents is relatively low, and typically of the order of 100 nanoamps per square centimetre (nA/cm²) for voltages of around 3.3 volts and for thicknesses of greater than a few tens of angströms. The breakdown field measured on these Ta₂O₅ and TiO₂ alloy layers is around 6.2 megavolts per centimetre (MV/cm), which value is to be compared with the breakdown fields of 2 and 5 MV/cm for respectively TiO₂ and Ta₂O₅ layers taken separately.

Moreover, these two TiO₂-Ta₂O₅ alloy layers are separated by an interlayer based on hafnium dioxide and alumina, or even possibly on zirconium dioxide, which further improves the performance characteristics of the nanolaminated structure.

Surprisingly, it has been found that hafnium dioxide-zirconium dioxide-alumina alloys have properties which are similar to the most favourable properties of each of the components of the alloy.

Thus, hafnium dioxide is known to be a material of polycrystalline structure. This crystalline structure results in hafnium dioxide being the site of relatively high leakage currents, although this material is very insensitive to avalanche phenomena on account of inter alia its high density.

However, the leakage currents of hafnium dioxide are limited because of its atomic composition and its low oxygen vacancy density. Hafnium oxide is also resistant to interfacial impurity diffusion and intermixing, especially because of its high density, namely 9.68 g/cm². The mechanism for these leakage currents is based on tunnel effects.

Hafnium dioxide is also known for its somewhat high relative permittivity, of around 20, when this material is deposited by ALD (Atomic Layer Deposition) at a temperature below 350° C.

With regard to the voltage withstand, hafnium dioxide has a band gap energy of 5.68 eV for a breakdown field of 4 MV/cm.

As regards the uniformity of the relative permittivity, the current-voltage plot exhibits hysteresis for a 10 millivolt voltage range. This means that, for a slight variation in voltage applied to the material, the latter does not have exactly the same permittivity properties, which may introduce defects in the electrical behaviour of the capacitor, especially when it is subjected to voltage jumps.

Moreover, zirconium dioxide is also known to be a material of polycrystalline structure. Zirconium dioxide is the site of relatively high leakage currents, even higher than those of hafnium dioxide, on account of the fact that zirconium dioxide has a relatively large number of oxygen vacancies.

As regards the voltage withstand, zirconium dioxide has a relatively high band gap energy of 7.8 eV and has a relatively low breakdown field of around 2.2 MV/cm.

The relative permittivity of zirconium dioxide is relatively high, around 22.

As regards the other component of the interlayer alloy, namely alumina, this is known to possess an amorphous crystalline structure, favourable to low leakage currents, which follow the Poole-Frenkel mechanism. Alumina has a relative permittivity of 8.4, which value is less than that of hafnium and zirconium dioxides.

On the other hand, alumina has a band gap energy of 8.7 eV and a breakdown field of 7 MV/cm, which values are greater than the abovementioned values of hafnium and zirconium dioxides.

Now, it has surprisingly been found that HfₓZrₜAl_{y}O_{z} alloys formed by these three materials have particularly beneficial properties especially as regards relative permittivity which is around 14 to 20. The voltage withstand is also advantageous, since the overall breakdown field is around 8.9 MV/cm.

Moreover, the alloys based on HfO₂, ZrO₂ and Al₂O₃ make it possible to stop hafnium and zirconium dioxide grain growth by the amorphous alumina phases. What is therefore obtained is the result that is characterized by a reduction in leakage currents, whereas a priori the two materials taken separately do not have a common mechanism as regards leakage currents.

The HfₓZrₜAl_{y}O_{z} alloys formed and deposited by ALD have advantages over a nanolaminated structure that would be composed of a stack of successive HfO₂, ZrO₂ and Al₂O₃ layers. These advantages are intimately connected with the structure of the grains of the alloy, with its density and with the enthalpy of formation, which give leakage currents of the order of 10⁻⁷ A/cm² at 6 V for a thickness of the order of a hundred angströms. Furthermore, the relative permittivity is higher and the electron transition (or barrier) energy with respect to a metal is greater than 3.4 eV. The band gap of the HfₓZrₜAl_{y}O_{z} alloy is greater than 7.6 eV, while the nanolaminated structure composed of HfO₂, ZrO₂ and Al₂O₃ layers has a band gap energy of 5.7 eV.

In practice, the layers located between the dioxide (TiO₂)-pentoxide (Ta₂O₅) alloy layers and the outside of the structure may consist of alloys produced from at least two materials chosen from the group comprising:

hafnium dioxide (HfO₂);

alumina (Al₂O₃);

zirconium dioxide (ZrO₂);

titanium dioxide (TiO₂); and

tantalum pentoxide (Ta₂O₅).

Moreover, the high cohesion of the crystals and the low oxygen vacancy density lead to good uniformity of the relative permittivity of the characteristic alloys when these are deposited by the ALD technique. The observed leakage currents are typically of the order of 1 nanoamp per cm² under a voltage of less than 5 volts.

In one particular embodiment, the multilayer structure of the invention may include external layers that are made only of alumina since, in this case, it is observed that alumina, Al₂O₃, has a high breakdown value and a relatively high band gap energy compared with the principal metals, especially tungsten, widely used to form electrodes of capacitive structures. The transition voltage threshold between alumina and tungsten is about 3.4 volts, which makes alumina particularly advantageous at the interface with metal, especially tungsten, electrodes.

### ILLUSTRATIVE EXAMPLES

The various nanolaminated structures described below were produced using ALD techniques, by depositing the various components of the alloy simultaneously at a temperature of between 320 and 350° C.

By using this technique, it is possible to control the thickness of each of the layers and thus to guarantee good homogeneity of this layer over the entire surface of the elementary layer, and therefore to avoid sources of defects.

The ALD technique may use several sources of materials, namely solid, liquid or gaseous sources, which makes this technique very flexible and versatile. Moreover, it uses precursors which are the vectors of the chemical surface reaction and which transport material to be deposited. More specifically, this transport involves a process of chemisorption of the precursors on the surface to be covered, creating a chemical reaction with ligand exchange between the surface atoms and the precursor molecules.

The principle of this technique avoids the adsorption or condensation of the precursors, and therefore their decomposition. The nucleation sites are continually created until saturation of each phase of the reaction, between which a purge with an inert gas allows the process to be repeated. Deposition uniformity is ensured by the reaction mechanism and not by the reactants used, as is the case in CVD (Chemical Vapour Deposition) techniques since the thickness of the layers deposited by ALD depends on each precursor chemisorption cycle.

For this technique, it will be preferred to use, as precursors, chlorides and oxychlorides such as HfCl₄, ZrCl₄, TiI₄ and TaCl₅ under an atmosphere of trimethyl ammonium (TMA) and ozone or H₂O, metallocenes, metal acyls, such as Al(CH₃)₃, beta-diketonates, or alkoxides.

Among the various examples produced, the following should be noted:

### Example A

| | | |
|---|---|---|
| | Formula of the | Thickness of the |
| No. of the layer | layer | layer |

| | | | |
|---|---|---|---|
| 1 | Al₂O₃ | 4.5 | angströms |
| 2 | HfZrO₄ | 5 | angströms |
| 3 | TiTa₂O₇ | 9 | angströms |
| 4 | Hf₃Al₂O₉ | 6 | angströms |
| 5 | TiTa₂O₇ | 10 | angströms |
| 6 | Hf₅AlO₁₁ | 5 | angströms |
| 7 | Al₂O₃ | 4.5 | angströms |

This nanolaminated structure has a relative capacitance of around 35 nF/mm², a breakdown field of 6.8 MV/cm, a band gap energy of 6.1 eV and an electron transition energy relative to tungsten nitride (WN) of 3.8 eV.

### Example B

| | | |
|---|---|---|
| | Formula of the | Thickness of the |
| No. of the layer | layer | layer |

| | | | |
|---|---|---|---|
| 1 | Hf₃Al₂O₉ | 2 | angströms |
| 2 | ZrTa₂O₇ | 2 | angströms |
| 3 | TiTa₂O₇ | 4.5 | angströms |
| 4 | Hf₅AlO_{5.5} | 3 | angströms |
| 5 | TiTa₂O₇ | 4.5 | angströms |
| 6 | ZrTa₂O₇ | 2 | angströms |
| 7 | Hf₃Al₂O₉ | 2 | angströms |

This nanolaminated structure has a relative capacitance of around 100 nF/mm² and a breakdown field of 7.3 MV/cm.

### Example C

| | | |
|---|---|---|
| | Formula of the | Thickness of the |
| No. of the layer | layer | layer |

| | | | |
|---|---|---|---|
| 1 | Hf₂ZrAl₂O₉ | 7 | angströms |
| 2 | TiTa₂O₇ | 10 | angströms |
| 3 | Hf₂ZrAlO_{7.5} | 8 | angströms |
| 4 | TiTa₂O₇ | 10 | angströms |
| 5 | HfZr₂AlO_{7.5} | 8 | angströms |
| 6 | HfZr₂Al₂O₉ | 7 | angströms |

Of course, the scope of the invention is not limited by the stoichometric values given for these various examples, rather the invention also covers many other variants provided that they respect the principle of the invention, namely a variation in the stoichiometry between the various components of the alloy from one layer to another.

1. Multilayer structure, especially used as a material of high relative permittivity, characterized in that it comprises a plurality of superposed elementary layers, each with a thickness of less than about 500 angströms (Å), among which there are two layers based on an alloy of titanium dioxide (TiO₂) and tantalum pentoxide (Ta₂O₅), these layers being separated by an interlayer of an alloy based on at least hafnium dioxide (HfO₂) an alumina (Al₂O₃).

2. Multilayer structure according to claim 1, characterized in that the interlayer is made of an alloy based on hafnium dioxide (HfO₂), alumina (Al₂O₃) and zirconium dioxide (ZrO₂).

3. Multilayer structure according to claim 1, characterized in that at least one of the layers lying between the titanium dioxide-tantalum pentoxide alloy layers and the outside of the structure consists of alloys produced from at least two materials chosen from the group comprising:
hafnium dioxide (HfO₂);
alumina (Al₂O₃);
zirconium dioxide (ZrO₂);
titanium dioxide (TiO₂); and
tantalum pentoxide (Ta₂O₅).

4. Multilayer structure according to claim 1, characterized in that the thickness of each layer is between 1 and 200 Å, preferably between 1 and 100 Å, and very preferably between 1 and 50 Å.

5. Multilayer structure according to claim 1, characterized in that at least one of the external layers is made of alumina (Al₂O₃).

6. Multilayer structure according to claim 1, characterized in that each layer is deposited by the technique of atomic layer deposition (ALD).
